(19) United States
(12) Patent Application Publication
(10) Pub. No.: US 2026/0189931 A1
(43) Pub. Date: Jul. 2, 2026

(54) COMMUNICATION METHOD, USER EQUIPMENT, AND RELAY APPARATUS

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/552,116

(22) Filed: Feb. 27, 2026

Related U.S. Application Data
(63) Continuation of application No. PCT/JP2024/030522, filed on Aug. 27, 2024.

(30) Foreign Application Priority Data
Aug. 31, 2023 (JP) 2023-141721

(51) Int. Cl. H04W 16/28; H04W 92/18

(52) U.S. Cl. CPC H04W 16/28; H04W 92/18

(57) ABSTRACT

A communication method using a relay apparatus including a relay device that performs relay transmission of relaying a radio signal and a control terminal that controls the relay device, the communication method including: communicating, by a user equipment, information regarding a beam formed by the relay device to the control terminal and/or a network node; and performing, by the user equipment, sidelink communication with another user equipment via the relay device based on the communicating.

### RELATED APPLICATIONS

The present application is a continuation based on PCT Application No. PCT/JP 2024/030522, filed on Aug. 27, 2024, which claims the benefit of Japanese Patent Application No. 2023-141721 filed on Aug. 31, 2023. The content of which is incorporated by reference herein in their entirety.

### TECHNICAL FIELD

The present disclosure relates to a communication method, a user equipment, and a relay apparatus that are used in a mobile communication system.

### BACKGROUND

In recent years, a mobile communication system of the fifth generation (5G) has been attracting attention. New Radio (NR), which is a radio access technology of the 5G system, is capable of wide-band transmission via a high frequency band as opposed to Long Term Evolution (LTE), which is a fourth-generation radio access technology.

Since radio signals (radio waves) in the high frequency band such as a millimeter wave band or a terahertz wave band have high degrees of straight-line propagation, reduction of coverage of a network node (for example, a base station) is a problem. In order to solve such a problem, a repeater apparatus that is a type of relay apparatus configured to perform relay transmission for relaying radio signals between the network node and a user equipment and can be controlled from the network node is attracting attention (see, for example, Non-Patent Document 1).

Such a repeater apparatus can extend the coverage of the network node while suppressing occurrence of interference by, for example, amplifying a radio signal received from the base station and transmitting the radio signal via directional transmission (by beam forming). Note that such a repeater apparatus is referred to as a network-controlled repeater (NCR).

As another example of the relay apparatus that performs relay transmission, a Reconfigurable Intelligent Surface (RIS) apparatus configured to perform relay transmission by changing a propagation direction of an incident radio wave (radio signal) by reflection or refraction has also been researched. Such a RIS apparatus may also be controllable from the network node.

### CITATION LIST

### Non-Patent Literature

Non-Patent Document 1:3GPP Contribution: RP-213700, “New SI: Study on NR Network-controlled Repeaters”

### SUMMARY

In a first aspect, a communication method uses a relay apparatus. The relay apparatus includes a relay device configured to perform relay transmission of relaying a radio signal, and a control terminal configured to control the relay device. The communication method includes the steps of: communicating, by a user equipment, information regarding a beam formed by the relay device to the control terminal and/or a network node; and performing, by the user equipment, sidelink communication with another user equipment via the relay device based on the communicating.

In a second aspect, a user equipment is used in a mobile communication system. The mobile communication system includes a relay apparatus. The relay apparatus includes a relay device configured to perform relay transmission of relaying a radio signal and a control terminal configured to control the relay device. The user equipment includes: a wireless communicator configured to communicate information regarding a beam formed by the relay device to the control terminal and/or a network node; and a controller configured to perform sidelink communication with another user equipment via the relay device based on the communication.

In a third aspect, a relay apparatus includes a relay device configured to perform relay transmission of relaying a radio signal, and a control terminal configured to control the relay device. The control terminal is configured to communicate information regarding a beam formed by the relay device to a user equipment and/or a network node. The relay device is configured to relay sidelink communication between the user equipment and another user equipment, based on the communication.

### BRIEF DESCRIPTION OF THE DRAWINGS

FIG. 1 is a diagram illustrating a configuration of a mobile communication system according to an embodiment.

FIG. 2 is a diagram illustrating a configuration of a protocol stack of a wireless interface of a user plane handling data.

FIG. 3 is a diagram illustrating a configuration of a protocol stack of a wireless interface of a control plane handling signaling (control signal).

FIG. 4 is a diagram illustrating an example of an application scenario of an NCR apparatus (relay apparatus) according to a first embodiment.

FIG. 5 is a diagram illustrating an example of an application scenario of the NCR apparatus according to the first embodiment.

FIG. 6 is a diagram illustrating an example of a control method for the NCR apparatus according to the first embodiment.

FIG. 7 is a diagram illustrating an example of a configuration of a protocol stack in the NCR apparatus according to the first embodiment.

FIG. 8 is a diagram illustrating a configuration example of the NCR apparatus according to the first embodiment.

FIG. 9 is a diagram illustrating a configuration of a user equipment (UE) according to the embodiment.

FIG. 10 is a diagram illustrating an example of a configuration of a gNB (network node) according to the first embodiment.

FIG. 11 is a diagram for describing an example of an operation scenario according to the first embodiment.

FIG. 12 is a diagram illustrating an example of beams formed by the NCR apparatus according to the first embodiment.

FIG. 13 is a diagram for describing an example of an operation scenario according to the first embodiment.

FIG. 14 is a diagram illustrating a basic operation of the UE according to the first embodiment.

FIG. 15 is a diagram illustrating a first operation pattern of a mobile communication system according to the first embodiment.

FIG. 16 is a diagram illustrating a second operation pattern of the mobile communication system according to the first embodiment.

FIG. 17 is a diagram illustrating a third operation pattern of the mobile communication system according to the first embodiment.

FIG. 18 is a diagram illustrating an example of an application scenario of a RIS apparatus (relay apparatus) according to a second embodiment.

FIG. 19 is a diagram illustrating an example of a configuration of the RIS apparatus according to the second embodiment.

### DESCRIPTION OF EMBODIMENTS

A scenario in which a relay apparatus relays sidelink communication between user equipments is assumed. However, the relay apparatus may form a plurality of beams in different directions by beam forming. This makes it difficult for the relay apparatus to relay sidelink communication between user equipments by using an appropriate beam.

The present disclosure provides a relay apparatus capable of smoothly relaying sidelink communication.

According to an embodiment, a mobile communication system will be described with reference to the drawings. In the description of the drawings, the same or similar parts are denoted by the same or similar reference signs.

### (1) First Embodiment

A first embodiment will be described. In the first embodiment, a relay apparatus is a repeater apparatus (that is, an NCR apparatus) that can be controlled from a network.

### (1.1) Overview of Mobile Communication System

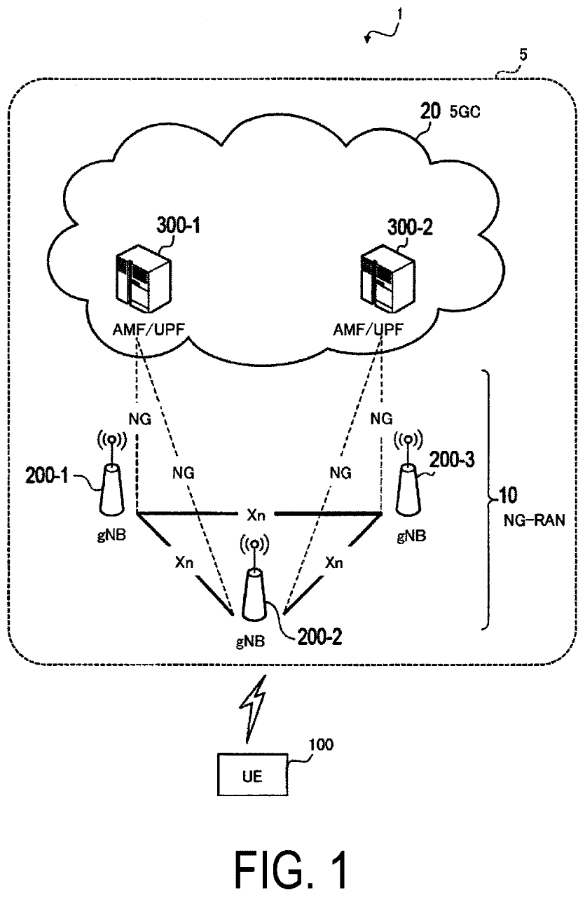

First, an overview of a mobile communication system 1 according to the first embodiment will be described. FIG. 1 is a diagram illustrating a configuration of a mobile communication system according to the first embodiment.

A mobile communication system 1 complies with the 5th Generation System (5GS) of the 3rd Generation Partnership Project (3GPP)(trade name, the same applies below) standard. The description below takes the 5GS as an example, but a Long Term Evolution (LTE) system may be at least partially applied to the mobile communication system. Alternatively, a sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network 5 of the mobile communication system 1.

The UE 100 is a mobile wireless communication apparatus. The UE 100 may be any apparatus as long as the UE 100 is used by a user. Examples of the UE 100 include a mobile phone terminal (including a smartphone) or a tablet terminal, a laptop PC, a communication module (including a communication card or a chipset), a sensor or an apparatus provided in or on a sensor, a vehicle or an apparatus provided on a vehicle (Vehicle UE), and a flying object or an apparatus provided on a flying object (Aerial UE).

The NG-RAN 10 includes base stations (referred to as “gNBs” or “NG-RAN nodes” in the 5G system) 200. The base station is a type of network node. The gNBs 200 are interconnected via an Xn interface that is an inter-node interface (inter-base station interface). Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

The gNB 200 may be functionally divided into a central unit (CU) and a distributed unit (DU). The CU controls the DU. The CU is a unit including upper layers included in a protocol stack, which will be described below, such as an RRC layer, an SDAP layer, and a PDCP layer, for example. The CU is connected to a core network via an NG interface which is a backhaul interface. The CU is connected to a neighboring base station via the Xn interface. The DU forms a cell. The DU 202 is a unit including lower layers included in the protocol stack, which will be described below, such as an RLC layer, a MAC layer, and a PHY layer, for example. The DU is connected to the CU via an F1 interface which is a fronthaul interface.

Note that the gNB can be connected to an Evolved Packet Core (EPC) corresponding to a core network of LTE. An LTE base station can also be connected to the 5GC. The LTE base station and the gNB can be connected via an inter-base station interface.

The 5 GC 20 includes an Access and Mobility Management Function (AMF) and a User Plane Function (UPF) 300. The AMF performs various types of mobility control and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

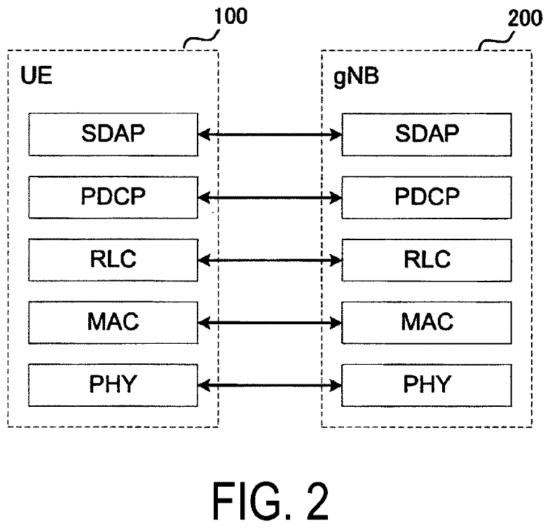

FIG. 2 is a diagram illustrating a configuration of a protocol stack of a wireless interface of a user plane handling data.

A wireless interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 on a physical downlink control channel (PDCCH). Specifically, the UE 100 performs blind decoding of PDCCH using a radio network temporary identifier (RNTI) and acquires successfully decoded DCI as DCI addressed to the UE. The DCI transmitted from the gNB 200 is added with Cyclic Redundancy Code (CRC) bits scrambled by the RNTI.

The gNB 200 transmits a synchronization signal block (Synchronization Signal/PBCH block (SSB)). For example, the SSB includes four consecutive Orthogonal Frequency Division Multiplex (OFDM) symbols, and a primary synchronization signal (PSS), a secondary synchronization signal (SSS), a physical broadcast channel (PBCH)/master information block (MIB), and a demodulation reference signal (DMRS) of the PBCH are arranged. A bandwidth of the SSB is, for example, a bandwidth of 240 consecutive subcarriers, that is, 20 RB.

The MAC layer performs priority control of data, retransmission processing through hybrid ARQ (Hybrid Automatic Repeat reQuest (HARQ)), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) for the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an Internet Protocol (IP) flow as the unit of Quality of Service (QoS) control that is performed by a core network and a radio bearer as the unit of QoS control that is performed by an Access Stratum (AS). Note that, when the RAN is connected to the EPC, the SDAP need not be provided.

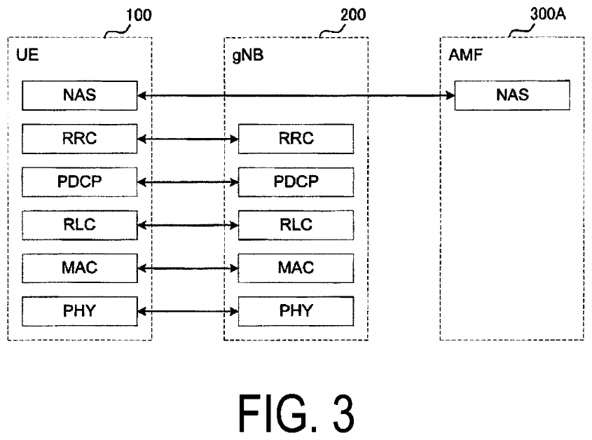

FIG. 3 is a diagram illustrating a configuration of a protocol stack of a wireless interface of a control plane handling signaling (a control signal).

The protocol stack of the wireless interface of the control plane includes a Radio Resource Control (RRC) layer and a Non-Access Stratum (NAS) layer instead of the SDAP layer illustrated in FIG. 2.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer, which is located above the RRC layer, performs session management, mobility management, and the like. NAS signaling is transmitted between the NAS layer of the UE 100 and the NAS layer of an AMF 300A. Note that the UE 100 includes an application layer other than the protocol of the wireless interface. A layer lower than the NAS layer is referred to as an Access Stratum (AS).

### (1.2) Example of Application Scenario of Relay Apparatus

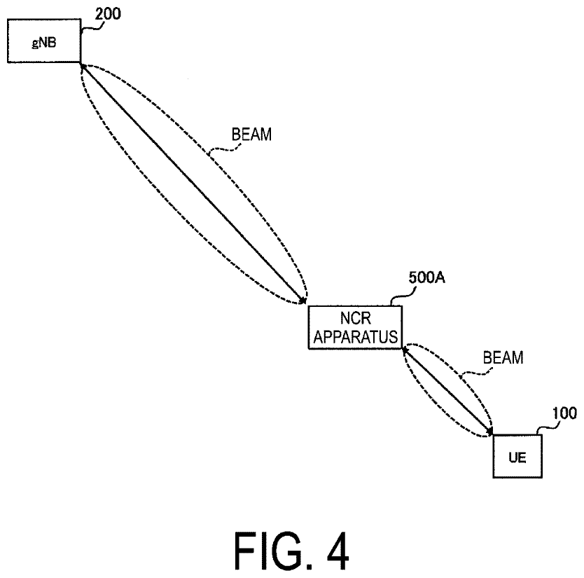

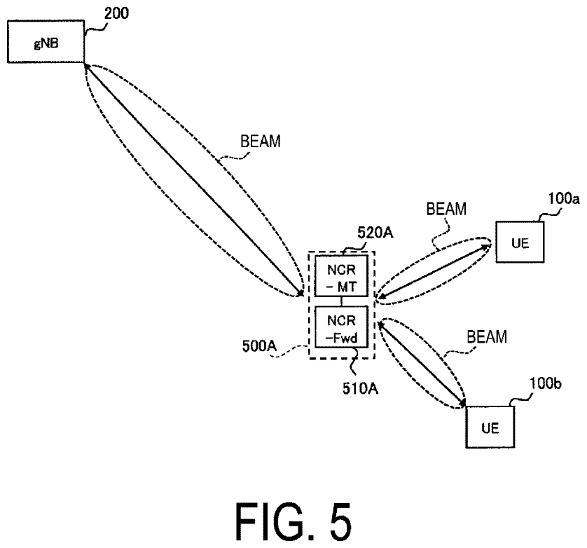

An application scenario for the NCR apparatus (relay apparatus) according to the first embodiment will be described below. FIGS. 4 and 5 are diagrams illustrating an example of the application scenario of the NCR apparatus according to the first embodiment. Note that the NCR apparatus may be referred to as an NCR node.

The 5G/NR is capable of wide-band transmission via a high frequency band compared to the 4G/LTE. Since radio signals in the high frequency band such as a millimeter wave band or a terahertz wave band have a high degree of straight-line propagation, a problem is reduction of coverage of the gNB 200. In FIG. 4, the UE 100 may be located outside a coverage area of the gNB 200, for example, outside an area where the UE 100 can receive radio signals directly from the gNB 200. The UE 100 may be in a state of not being able to communicate with the gNB 200 within a line of sight because of obstacles existing between the gNB 200 and the UE 100.

As illustrated in FIG. 4, an NCR apparatus 500A is introduced into the mobile communication system 1, wherein the NCR apparatus 500A is a repeater apparatus as a type of relay apparatus relaying radio signals between the gNB 200 and the UE 100, and can be controlled from the network 5. Such a repeater apparatus may be called a smart repeater apparatus.

For example, the NCR apparatus 500A amplifies a radio signal (radio wave) received from the gNB 200 and transmits the radio signal through directional transmission. To be specific, the NCR apparatus 500A receives a radio signal transmitted from the gNB 200 by beam forming. The NCR apparatus 500A amplifies the received radio signal without demodulation and modulation and transmits the amplified radio signal through the directional transmission. Here, the NCR apparatus 500A may transmit the radio signal with a fixed directivity (beam). The NCR apparatus 500A may transmit a radio signal with a variable (adaptive) directional beam. This can efficiently extend the coverage of the gNB 200.

As illustrated in FIG. 5, a new UE (hereinafter referred to as “NCR-MT (Mobile Termination)”) 100B, which is a type of control terminal for controlling the NCR apparatus 500A, is introduced. That is, the NCR apparatus 500A includes an NCR-Fwd (Forwarding) 510A, which is a type of a relay device that relays a radio signal transmitted between the gNB 200 and the UE 100, specifically, changes a propagation state of the radio signal without demodulating or modulating the radio signal, and an NCR-MT 520A that performs wireless communication with the gNB 200 to control the NCR-Fwd 510A.

Thus, the NCR-MT 520A controls the NCR apparatus 500A in cooperation with the gNB 200 by establishing a wireless connection to the gNB 200 and performing wireless communication with the gNB 200. Accordingly, efficient coverage extension can be achieved using the NCR apparatus 500A. The NCR-MT 520A controls the NCR apparatus 500A according to control from the gNB 200. The NCR-MT 520A also has a function the same as and/or similar to that of the UE 100.

The NCR-MT 520A may be configured separately from the NCR-Fwd 510A. For example, the NCR-MT 520A may be located near the NCR-Fwd 510A and may be electrically connected to the NCR-Fwd 510A. The NCR-MT 520A may be connected to the NCR-Fwd 510A in a wired or wireless manner. The NCR-MT 520A may be configured integrally with the NCR-Fwd 510A. The NCR-MT 520A and the NCR-Fwd 510A may be fixedly installed at a coverage edge (cell edge) of the gNB 200, or on a wall surface or window of any building, for example. The NCR-MT 520A and the NCR-Fwd 510A may be installed, for example, in or on a vehicle or the like and may be mobile. One NCR-MT 520A may control a plurality of NCR-Fwds 510A.

The configuration is not limited to a configuration in which the NCR-MT 520A directly controls one or more NCR-Fwds 510A, and may be a configuration in which the NCR-MT 520A indirectly controls one or more NCR-Fwds 510A. For example, the NCR-MT 520A may control one or more NCR-Fwds 510A via an upper layer (for example, an application layer).

In the example illustrated in FIG. 5, the NCR apparatus 500A (NCR-Fwd 510A) dynamically or quasi-statically changes a beam to be transmitted or received. For example, the NCR-Fwd 510A forms a beam toward each of a UE 100a and a UE 100b. The NCR-Fwd 510A may also form a beam toward the gNB 200. For example, in a communication resource between the gNB 200 and the UE 100a, the NCR-Fwd 510A transmits a radio signal received from the gNB 200 toward the UE 100a by beam forming and/or transmits a radio signal received from the UE 100a toward the gNB 200 by beam forming. In a communication resource between the gNB 200 and the UE 100b, the NCR-Fwd 510A transmits a radio signal received from the gNB 200 toward the UE 100b by beam forming and/or transmits a radio signal received from the UE 100b toward the gNB 200 by beam forming. Instead of or in addition to the beam forming, the NCR-Fwd 510A may perform null forming (so-called null steering) toward the UE 100 which is not a communication partner (not illustrated) and/or a neighboring gNB 200 (not illustrated) to suppress interference.

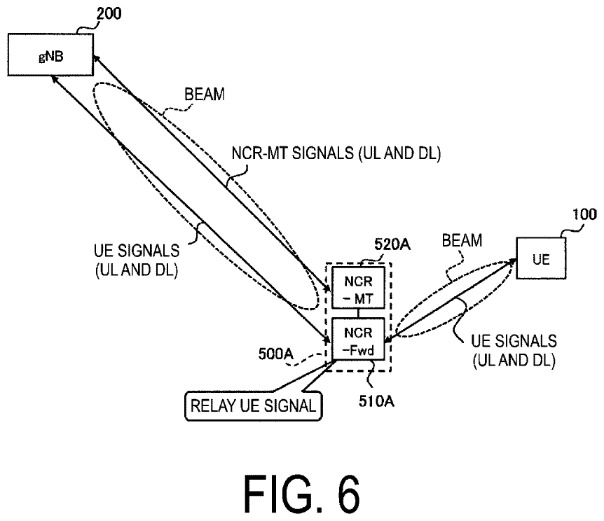

FIG. 6 is a diagram illustrating an example of a control method for the NCR apparatus 500A according to the first embodiment.

The NCR-Fwd 510A relays radio signals (also referred to as “UE signals”) between the gNB 200 and the UE 100. The UE signal includes an uplink signal transmitted from the UE 100 to the gNB 200 (also referred to as a “UE-UL signal”) and a downlink signal transmitted from the gNB 200 to the UE 100 (also referred to as a “UE-DL signal”). The NCR-Fwd 510A relays the UE-UL signal from the UE 100 to the gNB 200 and relays the UE-DL signal from the gNB 200 to the UE 100. A radio link between the NCR-Fwd 510A and the UE 100 is also referred to as an “access link”. A radio link between the NCR-Fwd 510A and the gNB 200 is also referred to as a “backhaul link”.

The NCR-MT 520A transmits and/or receives a radio signal (herein referred to as an “NCR-MT signal”) to and from the gNB 200. The NCR-MT signal includes an uplink signal transmitted from the NCR-MT 520A to the gNB 200 (referred to as an “NCR-MT-UL signal”), and a downlink signal transmitted from the gNB 200 to the NCR-MT 520A (referred to as an “NCR-MT-DL signal”). The NCR-MT-DL signal includes signaling for controlling the NCR apparatus 500A (for example, an NCR control signal). A radio link between the NCR-MT 520A and the gNB 200 is also referred to as a “control link”.

The gNB 200 directs a beam to the NCR-MT 520A based on the NCR-MT-UL signal from the NCR-MT 520A. Since the NCR apparatus 500A and the NCR-MT 520A are co-located, the gNB 200 directs a beam to the NCR-MT 520A under the condition that the backhaul link and the control link have the same frequency, the beam is also eventually directed to the NCR-Fwd 510A. The gNB 200 transmits the NCR-MT-DL signal and the UE-DL signal by using the beam. The NCR-MT 520A receives the NCR-MT-DL signal. Note that when the NCR-Fwd 510A and the NCR-MT 520A are at least partially integrated, a function (for example, antennas) for transmitting and/or receiving, or relaying UE signals and/or NCR-MT signals may be integrated in the NCR-Fwd 510A and the NCR-MT 520A. Note that the beam includes a transmission beam and/or a reception beam. The beam is a general term for transmission and/or reception under control for maximizing power of a transmission wave and/or a reception wave in a specific direction by adjusting/adapting an antenna weight or the like.

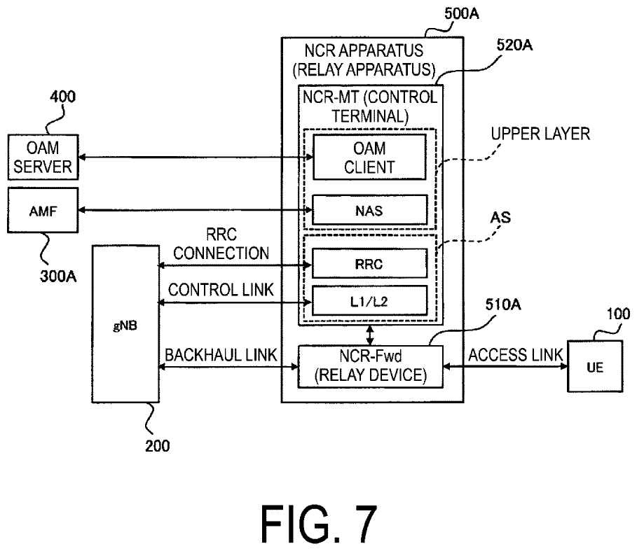

FIG. 7 is a diagram for describing an example of a configuration of a protocol stack in the NCR apparatus 500A according to the first embodiment.

The NCR-Fwd 510A relays a radio signal transmitted and/or received between the gNB 200 and the UE 100. The NCR-Fwd 510A has a Radio Frequency (RF) function of amplifying and relaying the received radio signal, and performs directional transmission by beam forming (for example, analog beam forming).

The NCR-MT 520A includes entities of the layer 1 and/or the layer 2 (L1/L2), and each layer of the RRC and the NAS. The L1/L2 (in particular, PHY, MAC) and the RRC of the NCR-MT 520A are also referred to as the “AS of the NCR-MT 520A”.

The NCR-MT 520A may include at least one selected from the group consisting of an Operation, Administration, Maintenance (OAM) client that communicates with an OAM server 400, a NAS layer that communicates with the AMF 300A, and an F1 Application Protocol (AP) layer. The OAM client, the NAS layer, and the F1-AP layer of the NCR-MT 520A are also referred to as “upper layers of the NCR-MT 520A” with reference to the AS of the NCR-MT 520A.

A backhaul link is established between the gNB 200 and the NCR-Fwd 510A. An access link is established between the UE 100 and the NCR-Fwd 510A. The NCR-Fwd 510A relays a radio signal transmitted between the gNB 200 and the UE 100 via the backhaul link and the access link. The NCR-Fwd 510A changes a propagation state of the radio signal without demodulating or modulating the radio signal.

A control link is established between the gNB 200 and the L1/L2 of the NCR-MT 520A. The L1/L2 of the NCR-MT 520A transmits and/or receives L1/L2 signaling to and from the gNB 200 via the control link. An RRC connection is established between the gNB 200 and the RRC of the NCR-MT 520A. The RRC of the NCR-MT 520A transmits and/or receives an RRC message to and/or from the gNB 200 via the RRC connection. The NCR-MT 520A receives downlink signaling (also referred to as an “NCR control signal” or simply “control signal”) from the gNB 200 via the RRC connection and/or the control link.

The gNB 200 (transmitter 210) transmits the NCR control signal to the NCR-MT 520A. The NCR control signal may be an RRC message, which is a control signal of the RRC layer (that is, layer 3). The NCR control signal may be a MAC Control Element (CE), which is a control signal of the MAC layer (that is, layer 2). The NCR control signal may be Downlink Control Information (DCI), which is a control signal of the PHY layer (that is, layer 1). The NCR control signal may be UE-specific signaling. The NCR control signal may be broadcast signaling. The NCR control signal may be a fronthaul message (for example, F1-AP message). When the NCR-MT 520A is a type or part of a base station, the NCR-MT 520A may communicate with the gNB 200 via an AP of Xn (Xn-AP), which is an inter-base station interface.

Hereinafter, the NCR control signal transmitted in the RRC message (and/or a MAC CE) and used for static or semi-static control of the NCR-Fwd 510A is also referred to as “NCR configuration information” or simply “configuration information”. Such configuration information may be referred to as “side control configuration”. The RRC message may be an RRC reconfiguration message. The NCR configuration information includes, for example, information for configuring On/Off of the NCR-Fwd 510A. The NCR configuration information may include, for example, information for semi-static beam configuration of the NCR-Fwd 510A.

On the other hand, the NCR control signal transmitted in the L1/L2 signaling, that is, the DCI (and/or the MAC CE) and used for dynamic control of the NCR-Fwd 510A is also referred to as “NCR control information” or simply “control information”. The NCR control information may be referred to as “side control information”. CRC bits of the PDCCH for carrying the NCR control information are scrambled by a newly introduced dedicated RNTI. The dedicated RNTI is also referred to as “NCR-RNTI”. The NCR control information may include, for example, information for dynamic beam control of the NCR-Fwd 510A. The NCR configuration information may include information for indicating dynamic On/Off of the NCR-Fwd 510A.

For example, when the NCR-MT 520A is in an RRC connected state, the NCR apparatus 500A can turn on or off the NCR-Fwd 510A according to the NCR control information received from the gNB 200. On the other hand, after the NCR-MT 520A transitions to an RRC inactive state, the NCR apparatus 500A can turn on or off the NCR-Fwd 510A according to the latest (last) configuration information received from the gNB 200.

Further, the NCR control signal (for example, NCR configuration information by RRC and/or NCR control information by L1/L2 signaling) held by the NCR apparatus 500A (NCR-MT 520A) may be referred to as an NCR-Fwd context.

When a radio link failure (RLF) with the gNB 200 is detected by the NCR-MT 520A, the NCR-MT 520A executes cell selection and triggers RRC connection re-establishment (also referred to as “RRC re-establishment”). Here, when the NCR-MT 520A transitions to the RRC idle state because a suitable cell cannot be found in the cell selection, the NCR apparatus 500A turns off the NCR-Fwd 510A. Note that the NCR-Fwd 510A is in an off state during an RRC connection re-establishment procedure.

The NCR control signal may include frequency control information designating a center frequency of a radio signal (for example, a component carrier) that is a relay target in the NCR-Fwd 510A. When the NCR control signal received from the gNB 200 includes the frequency control information, the NCR-MT 520A (controller 523) controls the NCR-Fwd 510A such that the NCR-Fwd 510A relays a radio signal whose center frequency is indicated by the frequency control information as a target (step S2A). The NCR control signal may include a plurality of pieces of frequency control information designating center frequencies different from each other. Since the NCR control signal includes the frequency control information, the gNB 200 can designate the center frequency of the radio signal to be relayed by the NCR-Fwd 510A via the NCR-MT 520A.

The NCR control signal may include mode control information designating an operation mode of the NCR-Fwd 510A. The mode control information may be associated with the frequency control information (center frequency). The operation mode may be any one of a mode in which the NCR-Fwd 510A performs non-directional transmission and/or reception, a mode in which the NCR-Fwd 510A performs fixed-directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beam forming mode (that is, a mode in which improvement of a desired wave is emphasized) or a null steering mode (that is, a mode in which suppressing of an interference wave is emphasized). When the NCR control signal received from the gNB 200 includes the mode control information, the NCR-MT 520A (controller 523) controls the NCR-Fwd 510A such that the NCR-Fwd 510A operates in the operation mode indicated by the mode control information (step S2A). Since the NCR control signal includes the mode control information, the gNB 200 can designate the operation mode of the NCR-Fwd 510A via the NCR-MT 520A.

A mode in which the NCR apparatus 500A performs non-directional transmission and/or reception is a mode in which the NCR-Fwd 510A performs relaying in all directions, and may be referred to as an omni mode. The mode in which the NCR-Fwd 510A performs fixed-directional transmission and/or reception may be a directivity mode enabled by one directional antenna. The mode may be a beam forming mode achieved by applying fixed phase and amplitude control (antenna weight control) to a plurality of antennas. Any of these modes may be designated (set) from the gNB 200 to the NCR-MT 520A. The mode in which the NCR-Fwd 510A performs transmission and/or reception with a variable directional beam may be a mode for performing analog beam forming. The mode may be a mode in which digital beam forming is performed. The mode may be a mode in which hybrid beam forming is performed. The mode may be a mode for forming an adaptive beam specific to the UE 100. Any of these modes may be designated (set) from the gNB 200 to the NCR-MT 520A. Note that in the operation mode in which beam forming is performed, beam control information to be described below may be provided from the gNB 200 to the NCR-MT 520A. The mode in which the NCR apparatus 500A performs MIMO relay transmission may be a mode for performing Single-User (SU) spatial multiplexing. The mode may be a mode for performing Multi-User (MU) spatial multiplexing. The mode may be a mode for performing transmission diversity. Any of these modes may be designated (set) from the gNB 200 to the NCR-MT 520A. The operation mode may include a mode in which relay transmission by the NCR-Fwd 510A is turned on (activated) and a mode in which the relay transmission by the NCR-Fwd 510A is turned off (deactivated). Any of these modes may be designated (set) from the gNB 200 to the NCR-MT 520A in the NCR control signal.

The NCR control signal may include beam control information designating a transmission direction, a transmission weight, or a beam pattern when the NCR-Fwd 510A performs directional transmission. The beam control information may be associated with the frequency control information (center frequency). The beam control information may include a Precoding Matrix Indicator (PMI). The beam control information may include beam forming angle information. When the NCR control signal received from the gNB 200 includes beam control information, the NCR-MT 520A (controller 523) controls the NCR-Fwd 510A to form a transmission directivity (beam) indicated by the beam control information. When the NCR control signal includes the beam control information, the gNB 200 can control the transmission directivity of the NCR apparatus 500A via the NCR-MT 520A.

The NCR control signal may include power control information designating a transmission power or a degree (gain) by which the NCR-Fwd 510A amplifies a radio signal. The power control information may be information indicating a difference value (that is, a relative value) between a present gain or transmission power and a target gain or transmission power. When the NCR control signal received from the gNB 200 includes power control information, the NCR-MT 520A (controller 523) controls the NCR-Fwd 510A such that the NCR-Fwd 510A performs change to the gain or transmission power indicated by the transmission power control information. The power control information may be associated with frequency control information (center frequency). The power control information may be information designating any one selected from the group consisting of an amplification gain, a beam-forming gain, and an antenna gain of the NCR-Fwd 510A. The power control information may be information designating a transmission power of the NCR-Fwd 510A.

When one NCR-MT 520A controls a plurality of NCR-Fwds 510A, the gNB 200 (transmitter 210) may transmit an NCR control signal to the NCR-MT 520A for each NCR-Fwd 510A. In this case, the NCR control signal may include an identifier of the corresponding NCR-Fwd 510A (NCR identifier). The NCR-MT 520A (controller 523) controlling the plurality of NCR-Fwds 510A determines the NCR-Fwd 510A to which the NCR control signal is applied, based on the NCR identifier included in the NCR control signal received from the gNB 200. Note that the NCR identifier may be transmitted together with the NCR control signal from the NCR-MT 520A to the gNB 200 even when the NCR-MT 520A controls only one NCR-Fwd 510A.

Thus, the NCR-MT 520A (controller 523) controls the NCR-Fwd 510A based on the NCR control signal from the gNB 200. This enables the gNB 200 to control the NCR-Fwd 510A via the NCR-MT 520A.

### (1.3) Example of Configuration of Each Apparatus

In the first embodiment, an example of a configuration of each apparatus in the mobile communication system 1 will be described below.

### (1.3.1) Example of Configuration of Relay Apparatus

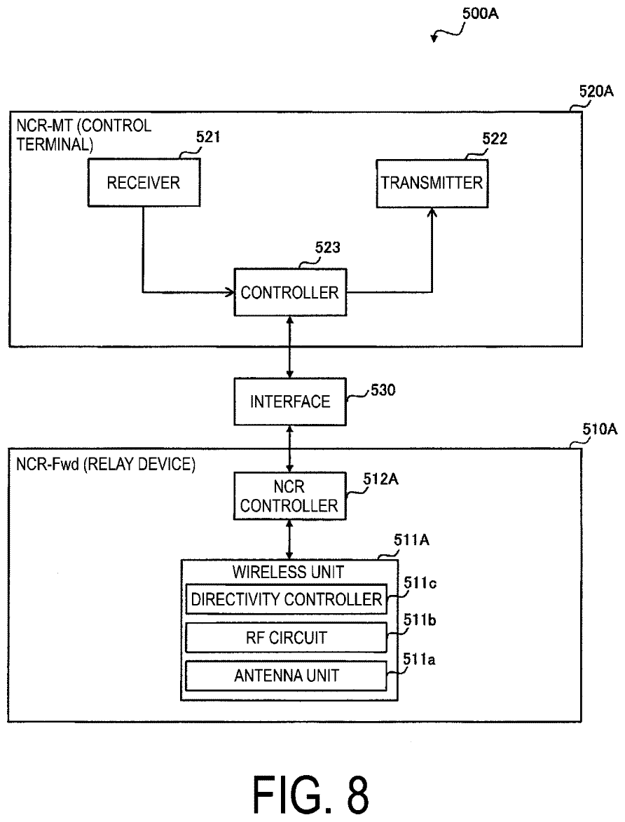

FIG. 8 is a diagram illustrating an example of a configuration of the NCR apparatus 500A (relay apparatus) according to the first embodiment. The NCR apparatus 500A includes the NCR-Fwd 510A, the NCR-MT 520A, and an interface 530.

The NCR-Fwd 510A includes a wireless unit 511A and an NCR controller 512A. The wireless unit 511A includes an antenna unit 511a including a plurality of antennas (a plurality of antenna elements), an RF circuit 511b including an amplifier, and a directivity controller 511c that controls directivity of the antenna unit 511a. The RF circuit 511b amplifies and relays (transmits) radio signals transmitted and/or received by the antenna unit 511a. The RF circuit 511b may convert a radio signal, which is an analog signal, into a digital signal, and reconvert the digital signal into an analog signal after digital signal processing. The directivity controller 511c may perform analog beam forming through analog signal processing. The directivity controller 511c may perform digital beam forming through digital signal processing. The directivity controller 511c may perform analog and digital hybrid beam forming. The NCR controller 512A controls the wireless unit 511A in response to a control signal from the NCR-MT 520A. The NCR controller 512A may include at least one processor.

The NCR-MT 520A includes a receiver 521, a transmitter 522, and a controller 523. The receiver 521 performs various types of reception under control of the controller 523. The receiver 521 includes an antenna and a reception device. The reception device converts a radio signal received through the antenna (a radio signal) into a baseband signal (a reception signal) and outputs the reception signal to the controller 523. The transmitter 522 performs various types of transmission under control of the controller 523. The transmitter 522 includes an antenna and a transmission device. The transmission device converts a baseband signal (a transmission signal) output by the controller 523 into a radio signal and transmits the radio signal from the antenna. The controller 523 performs various types of control in the NCR-MT 520A. The operation of the NCR-MT 520A (and the NCR apparatus 500A) described above and to be described below may be an operation controlled by the controller 523. The controller 523 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. The controller 523 executes a function of at least one layer selected from the group consisting of the PHY, the MAC, the RRC, and the F1-AP.

The interface 530 electrically or logically connects the NCR-Fwd 510A and the NCR-MT 520A. The controller 523 of the NCR-MT 520A controls the NCR-Fwd 510A via the interface 530. The interface 530 may be a logical entity of an upper layer (for example, an application layer).

In the first embodiment, the receiver 521 of the NCR-MT 520A receives signaling (NCR control signal) used for control of the NCR apparatus 500A from the gNB 200 through wireless communication. The controller 523 of the NCR-MT 520A controls the NCR apparatus 500A based on the signaling. This enables the gNB 200 to control the NCR-Fwd 510A via the NCR-MT 520A.

(1.3.2) Example of Configuration of User Equipment

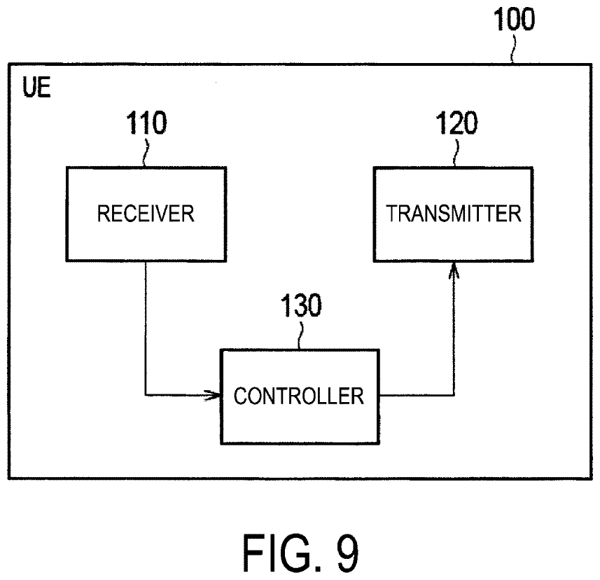

FIG. 9 is a diagram illustrating a configuration of the UE 100 (user equipment) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various types of transmission under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various types of control and processes in the UE 100. Such processing includes processing of respective layers to be described below. The operations of the UE 100 described above and to be described below may also be an operation under the control of the controller 130. The controller 130 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

### (1.3.3) Configuration Example of Network Node

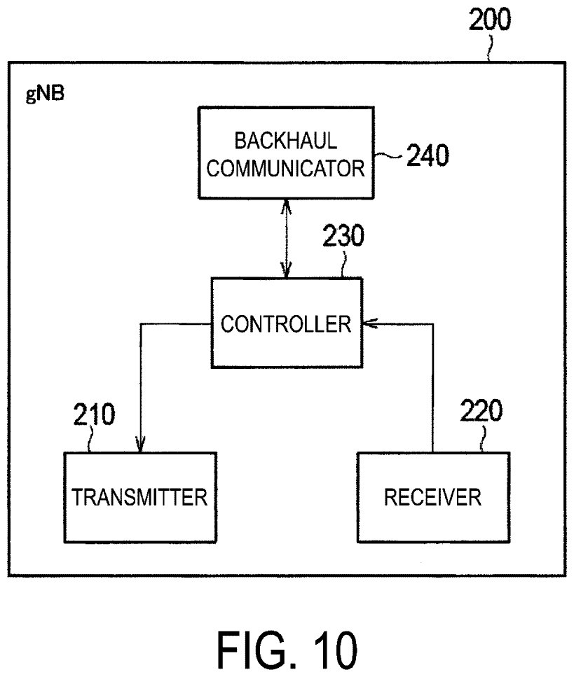

FIG. 10 is a diagram illustrating a configuration example of the gNB 200 (network node) according to the first embodiment. The gNB 200 includes a transmitter 210, a receiver 220, a controller 230, and a backhaul communicator 240.

The transmitter 210 performs various types of transmission under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna. The receiver 220 performs various types of reception under the control of the controller 230. The receiver 220 includes an antenna and a reception device. The reception device converts a radio signal or a terahertz wave signal received through the antenna into a baseband signal (a reception signal) and outputs the resulting signal to the controller 230. The transmitter 210 and the receiver 220 may be capable of beam forming using a plurality of antennas.

The controller 230 performs various types of control for the gNB 200. The operations of the gNB 200 described above and to be described below may be also performed under the control of the controller 230. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. Note that the gNB may include a Central Unit (CU) and a Distributed Unit (DU) (that is, functions are divided), and both units may be connected via an F1 interface.

In the first embodiment, the transmitter 210 of the gNB 200 transmits signaling (the NCR control signal) that is to be used for control of the NCR-Fwd 510A to the NCR-MT 520A through wireless communication. This enables the gNB 200 to control the NCR apparatus 500A via the NCR-MT 520A.

### (1.4) Operation of Mobile Communication System

An operation of the mobile communication system 1 according to the first embodiment will be described below.

### (1.4.1) Example of Operation Scenario

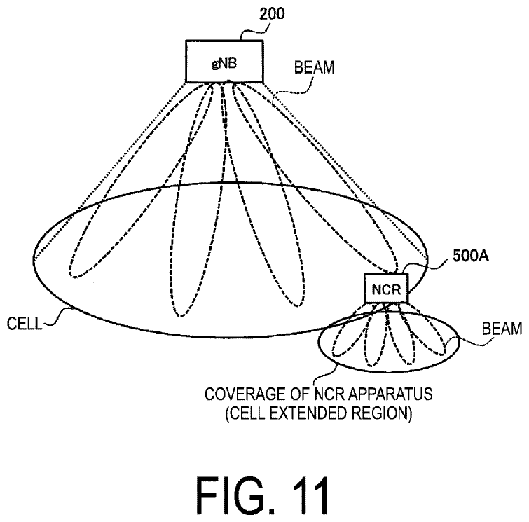

FIG. 11 is a diagram for describing an example of an operation scenario according to the first embodiment.

In the illustrated example, the NCR apparatus 500A is installed at the edge of the cell of the gNB 200. The NCR apparatus 500A is a RAN node including the NCR-Fwd 510A and the NCR-MT 520A. The NCR-Fwd 510A performs relay transmission between the gNB 200 and the UE 100, in particular, amplification and forwarding of UL/DL RF signals. The operation of the NCR-Fwd 510A is controlled according to the side control information (control signal/NCR control signal) that the NCR-MT 520A receives from the gNB 200. The NCR-MT 520A communicates with the gNB 200 via the control link to receive the side control information. The control link is based on the NR Uu interface.

The gNB 200 can form a plurality of beams by beam forming. The gNB 200 covers the coverage of the own cell by the plurality of beams. The gNB 200 may transmit a different SSB for each beam. The different SSBs may mean SSBs having different reference signal sequences. The gNB 200 may transmit the different SSBs in the own cell while switching the beams. The UE 100 that has received the SSB may perform transmission of a physical random access channel (PRACH) with a random access resource associated with the received SSB (beam) at the time of initial access. Any beam of the gNB 200 may be directed to the NCR apparatus 500A. The gNB 200 may transmit different SSBs in the beam directed to the NCR apparatus 500A in a time division manner. The NCR apparatus 500A (NCR-Fwd 510A) may perform relay transmission for the SSB received from the gNB 200.

The NCR apparatus 500A (NCR-Fwd 510A) can form a plurality of beams by beam forming. The NCR apparatus 500A (NCR-Fwd 510A) can extend the coverage of the cell of the gNB 200 by covering the own coverage with the plurality of beams. That is, the coverage of the NCR apparatus 500A (NCR-Fwd 510A) constitutes the extended region of the cell of the gNB 200. The NCR apparatus 500A (NCR-Fwd 510A) may be capable of forming a beam with any width in any direction. The NCR apparatus 500A (NCR-Fwd 510A) may be capable of covering an area in all directions (360°) by transmitting beams with the same width at the same angular intervals.

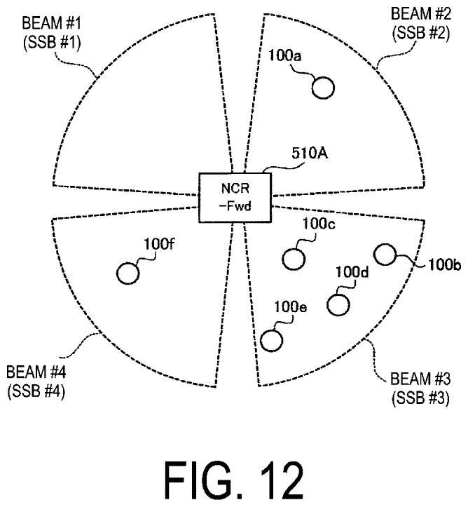

FIG. 12 is a diagram illustrating an example of beams formed by the NCR apparatus 500A according to the first embodiment. In the illustrated example, the NCR apparatus 500A (NCR-Fwd 510A) forms four beams with the width of 90° in a time division manner. The NCR apparatus 500A (NCR-Fwd 510A) may relay an SSB different for each beam. For example, the NCR apparatus 500A (NCR-Fwd 510A) relays the following SSBs at different timings (slots):
Beam #1: SSB #1
Beam #2: SSB #2
Beam #3: SSB #3
Beam #4: SSB #4
Note that each number following the symbol “#” may mean an identifier (index).

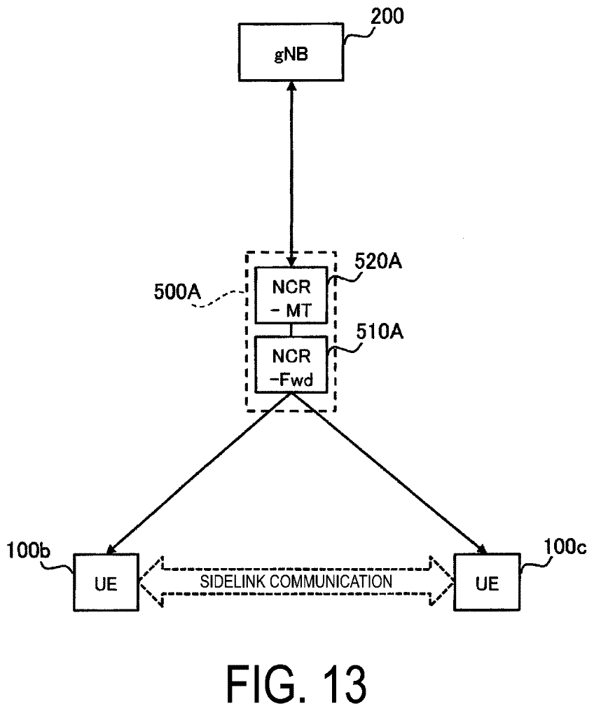

Under the premise as illustrated in FIG. 12, the NCR apparatus 500A (NCR-Fwd 510A) is assumed to relay sidelink communication between the UEs 100. To be specific, the NCR apparatus 500A (NCR-Fwd 510A) relays radio signals transmitted and received by the UEs 100 on the sidelink by relay transmission. As illustrated in FIG. 13, the NCR apparatus 500A (NCR-Fwd 510A) is assumed to relay sidelink communication between a UE 100b and a UE 100c. For example, when an obstacle is present between the UE 100b and the UE 100c and sidelink communication using a high frequency band is difficult between the UE 100b and the UE 100 c, the NCR apparatus 500A (NCR-Fwd 510A) relays the sidelink communication, thereby enabling the sidelink communication.

As illustrated in FIG. 12, the NCR apparatus 500A (NCR-Fwd 510A) serves the UE 100b and the UE 100c by forming the beam #3. Thus, the UE 100b and the UE 100c preferably perform the sidelink communication at the timing when the beam #3 is formed. However, the UE 100b and the UE 100c do not know a timing at which the NCR apparatus 500A (NCR-Fwd 510A) forms each beam. Thus, the UE 100b and the UE 100c are difficult to perform the sidelink communication at an appropriate timing (that is, a timing at which the beam #3 is formed).

Note that the sidelink communication means that the UEs 100 directly communicate with each other without the gNB 200. The term of “sidelink communication” may include “sidelink discovery” for discovering another UE 100 on the sidelink. The resource allocation mode in the sidelink communication includes the “mode 1″ and the ”mode 2″. In the mode 1, the network 5 (gNB 200) provides sidelink resource allocation. In the mode 2, the UE 100 selects a resource from a resource pool to determine the resource for sidelink transmission. In the first embodiment, the mode 2 is mainly assumed as the resource allocation mode in the sidelink communication.

### (1.4.2) Basic Operation

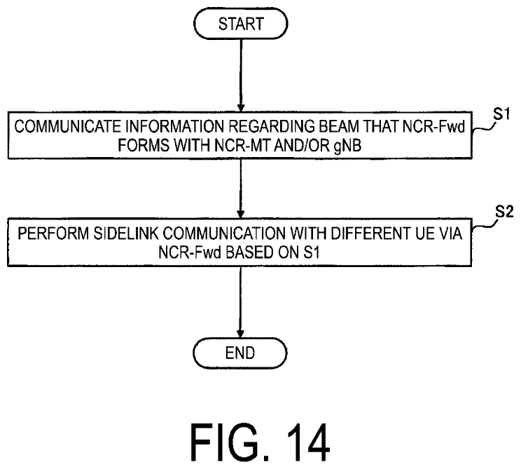

FIG. 14 is a diagram illustrating a basic operation of the UE 100 according to the first embodiment.

In step S1, the UE 100 communicates information regarding beams formed by the NCR-Fwd 510A to the NCR-MT 520A and/or the gNB 200.

In step S2, the UE 100 performs sidelink communication with another UE 100 via the NCR-Fwd 510A based on step S1.

In this way, the UE 100 communicates the information regarding the beams formed by the NCR-Fwd 510A to the NCR-MT 520A and/or the gNB 200, thereby making it easy to perform the sidelink communication at an appropriate timing. Note that the UE 100 that performs such an operation includes a wireless communicator (the receiver 110 and the transmitter 120) that communicates the information regarding the beams formed by the NCR-Fwd 510A to the NCR-MT 520A and/or the gNB 200, and the controller 130 that performs the sidelink communication with the other UE 100 via the NCR-Fwd 510A based on the communication.

In step S1, the UE 100 may receive, from the NCR-MT 520A via the sidelink, beam forming information regarding a configuration of the beams formed by the NCR-Fwd 510A. Alternatively, in step S1, the UE 100 may receive, from the gNB 200 in the downlink, the beam forming information regarding the configuration of the beams formed by the NCR-Fwd 510A. The beam forming information may be information indicating timings at which the NCR-Fwd 510A forms respective beams. For example, the beam forming information may include, for each of the plurality of beams formed by the NCR-Fwd 510A, at least one selected from the group consisting of a beam identifier of the beam, information indicating characteristics of the beam, and information indicating a timing at which the beam is formed. Accordingly, the UE 100 can know the timings at which the NCR-Fwd 510A forms the respective beams based on the beam forming information.

In step S2, the UE 100 may attempt the sidelink communication based on the beam forming information. For example, the UE 100 attempts the sidelink communication for each beam formed by the NCR apparatus 500A (NCR-Fwd 510A), and determines whether the sidelink communication is successfully established for each beam. The UE 100 may determine that the sidelink communication has been successfully established in response to correctly receiving date from the peer UE that is a communication partner of the sidelink communication and/or receiving an acknowledgement (ACK) from the peer UE. Based on the result of the attempt, the UE 100 may perform the sidelink communication at a timing at which the NCR apparatus 500A (NCR-Fwd 510A) forms a beam satisfying a predetermined condition. The beam satisfying the predetermined condition may be a beam with which the sidelink communication has been successfully established. The beam satisfying the predetermined condition may be a beam with which the sidelink communication has been successfully established and with which an error rate of sidelink communication data is the lowest.

In step S1, the UE 100 may transmit, to the NCR-MT 520A via the sidelink, notification information regarding a beam configuration of the NCR-Fwd 510A that the UE 100 itself desires. Alternatively, in step S1, the UE 100 may transmit, to the gNB 200 in the uplink, the notification information regarding the beam configuration of the NCR-Fwd 510A that the UE 100 itself desires. This can facilitate the NCR apparatus 500A (NCR-Fwd 510A) to form a beam suitable for the sidelink communication. The notification information may include identification information of the beam satisfying the predetermined condition. The identification information of the beam may be an index of an SSB successfully received by the UE 100. The notification information may include information corresponding to the result of the attempt of the sidelink communication based on the beam forming information. For example, the notification information may include a beam identifier of the beam satisfying the predetermined condition (specifically, a beam identifier provided through notification using the beam forming information).

### (1.4.3) Specific Example of Operation

A first operation pattern to a fourth operation pattern as specific examples of the operations of the mobile communication system 1 according to the first embodiment will be described. For these operation patterns, each operation pattern may be performed independently, or two or more operation patterns may be combined and performed.

### (1.4.3.1) First Operation Pattern

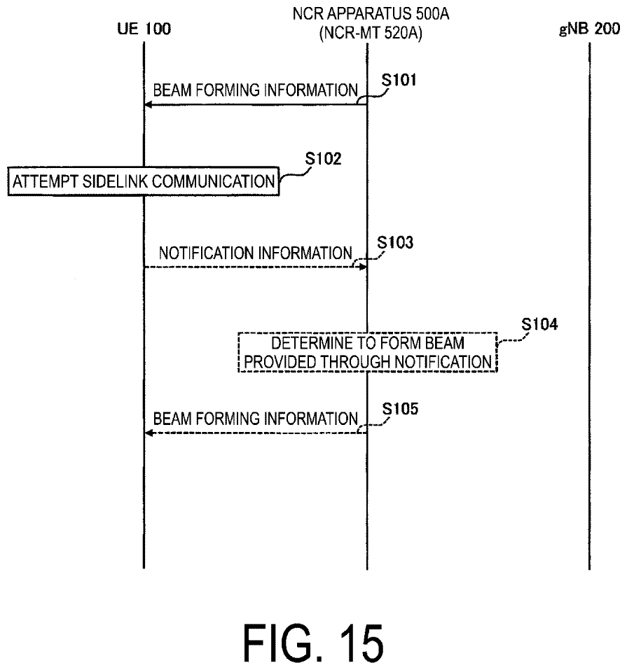

FIG. 15 is a diagram illustrating the first operation pattern of the mobile communication system 1 according to the first embodiment.

In step S101, the NCR-MT 520A transmits, to the UE 100 via the sidelink, beam forming information regarding a configuration of beams formed by the NCR-Fwd 510A. The UE 100 receives the beam forming information.

The NCR-MT 520A may broadcast the beam forming information on a sidelink broadcast channel (SL-BCH). For example, the NCR-MT 520A may broadcast a Master Information Block Sidelink message including the beam forming information via the sidelink. Alternatively, the NCR-MT 520A may broadcast a sidelink discovery message including the beam forming information via the sidelink. Alternatively, the NCR-MT 520A may transmit the beam forming information on a physical sidelink shared channel (PSSCH) by sidelink unicast or sidelink groupcast.

The beam forming information includes information of at least one selected from the group consisting of the following pieces of information 1) to 3) for each beam formed by the NCR-Fwd 510A.
1) Beam identifier (beam configuration ID):

This identifier is used for identifying the beam (beam configuration). For a beam in an off state, the beam identifier (beam configuration ID) may be set to zero or null.
2) Beam characteristic information (beam detailed information):

This information is used for indicating characteristics of the beam. For example, the beam characteristic information (beam detailed information) may include information regarding a direction (azimuth) of the beam and/or a beam width. Although details will be described below, when the relay apparatus is a RIS apparatus 500B, the beam characteristic information (beam detailed information) may include information regarding a reflection angle or a refraction angle.
3) Timing information:

This information indicates a timing at which the beam is formed. The timing information may include information of a time resource corresponding to the timing (for example, a frame number, a subframe number, a slot number, and/or a symbol number). Alternatively, arranged elements of the list of the beam identifiers (beam configuration IDs) may be associated with time resources, and each arranged element of the list may indicate the corresponding time resource. Alternatively, the timing information may be a set of a start timing and an end timing of beam forming, or a set of a start timing and a duration of beam forming. The timing information may be a set of offset information indicating a start timing of beam forming and information indicating a period of beam forming.

In step S102, the UE 100 attempts the sidelink communication based on the beam forming information received in step S101, and thus performs data transmission and/or data reception via the sidelink at a timing at which the most suitable beam is formed. For example, the UE 100 attempts the sidelink communication several times, identifies a beam identifier (beam configuration ID) at the best communication characteristics (for example, the lowest error ratio), and performs the sidelink communication at a beam formation timing corresponding to the beam identifier.

In step S103, the UE 100 may transmit, to the NCR-MT 520A, notification information indicating a beam configuration that the UE 100 itself desires (for example, the beam at the best communication characteristics in step S102) via the sidelink. The NCR-MT 520A receives the notification information. The UE 100 may transmit the notification information to the NCR-MT 520A on the PSSCH in sidelink unicast. The notification information includes information (for example, the beam identifier) corresponding to the beam that the UE 100 desires among the beam forming information received in step 101.

In step S104, the NCR-MT 520A may determine to form the beam by prioritizing the beam configuration desired by the UE 100, based on the notification information received in step 103. When receiving pieces of notification information from a plurality of UE 100, the NCR-MT 520A may perform beam control such that the most desired beam is formed for a long time and a less desired beam is formed for a short time (or not formed).

In step S105, the NCR-MT 520A may transmit, to the UE 100, beam forming information regarding the beam after the configuration change via the sidelink based on the determination in step S104.

### (1.4.3.2) Second Operation Pattern

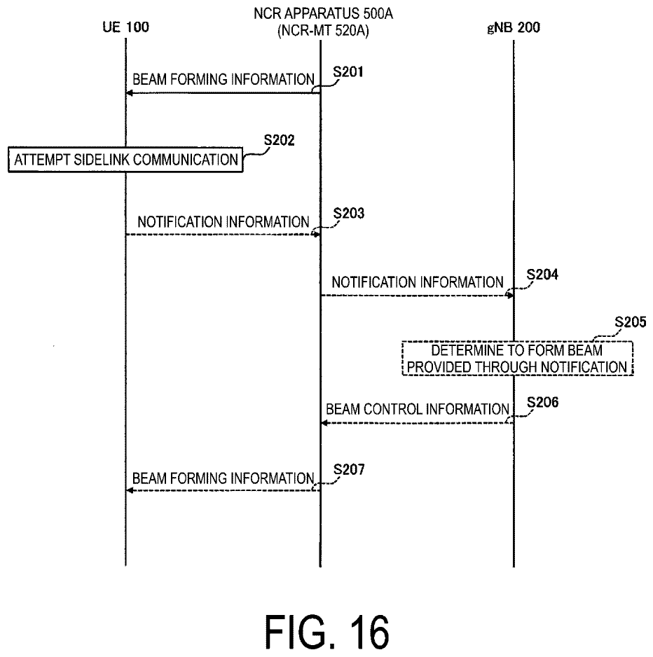

Differences of a second operation pattern of the mobile communication system 1 according to the first embodiment from the first operation pattern will be mainly described. FIG. 16 is a diagram illustrating the second operation pattern of the mobile communication system 1 according to the first embodiment.

Step S201 to step S203 are the same as and/or similar to those of the first operation pattern.

In step S204, the NCR-MT 520A transmits (transfers), to the gNB 200 on the control link, the notification information received from the UE 100 in step S203. The gNB 200 receives the notification information.

In step S205, the gNB 200 may determine to cause the NCR-Fwd 510A to form a beam with priority given to the beam configuration desired by the UE 100, based on the notification information received from NCR-MT 520A in step S204. When receiving pieces of notification information from a plurality of UEs 100 via the NCR-MT 520A, the gNB 200 may determine to form the most desired beam for a long time and to form a less desired beam for a short time (or not to form a less desired beam).

In step S206, the gNB 200 transmits beam control information indicating the content determined in step S205 to the NCR-MT 520A on the control link. The gNB 200 may transmit an RRC Reconfiguration message including the beam control information to the NCR-MT 520A. The NCR-MT 520A may change the beam configuration of the NCR-Fwd 510A based on the received beam control information.

In step S207, the NCR-MT 520A may transmit beam forming information regarding the beam after the configuration change to the UE 100 via the sidelink.

In this operation pattern, the notification information from the UE 100 is transmitted to the gNB 200 via the NCR-MT 520A, but the UE 100 may transmit the notification information directly to the gNB 200 in the uplink. For example, the UE 100 may transmit an RRC message including the notification information to the gNB 200.

### (1.4.3.3) Third Operation Pattern

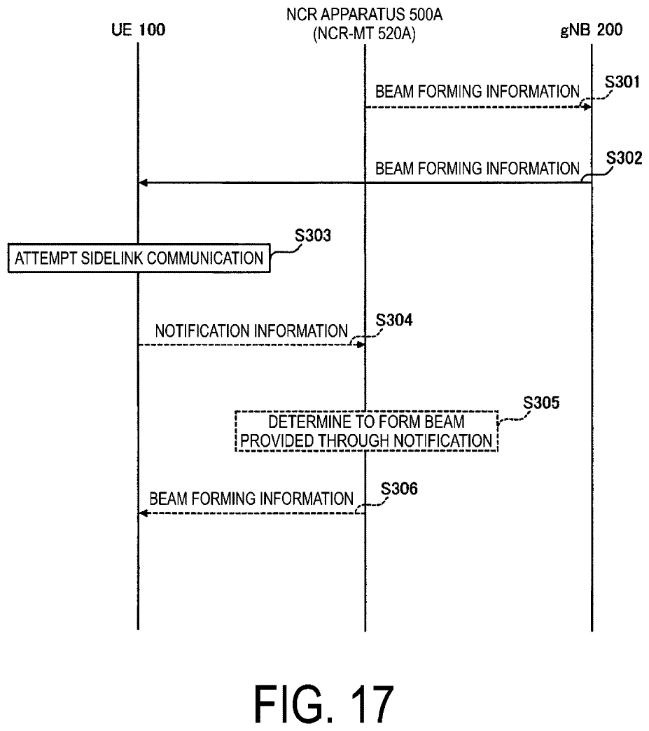

Differences of a third operation pattern of the mobile communication system 1 according to the first embodiment from the first operation pattern will be mainly described. FIG. 17 is a diagram illustrating the third operation pattern of the mobile communication system 1 according to the first embodiment.

In step S301, the NCR-MT 520A may transmit, to the gNB 200 on the control link, beam forming information regarding a configuration of beams formed by the NCR-Fwd 510A. The gNB 200 may receive the beam forming information. However, under the premise that the gNB 200 controls the beams formed by the NCR-Fwd 510A, step S301 is not necessary.

In step S302, the gNB 200 transmits beam forming information regarding the configuration of the beams formed by the NCR-Fwd 510A to the UE 100 in the downlink. The UE 100 receives the beam forming information. The gNB 200 may broadcast the beam forming information included in an SIB. The gNB 200 may transmit dedicated signaling (for example, an RRC Reconfiguration message) including the beam forming information to the UE 100. Note that the operations from step S303 to step S306 are the same as and/or similar to those of the first operation pattern.

### (2) Second Embodiment

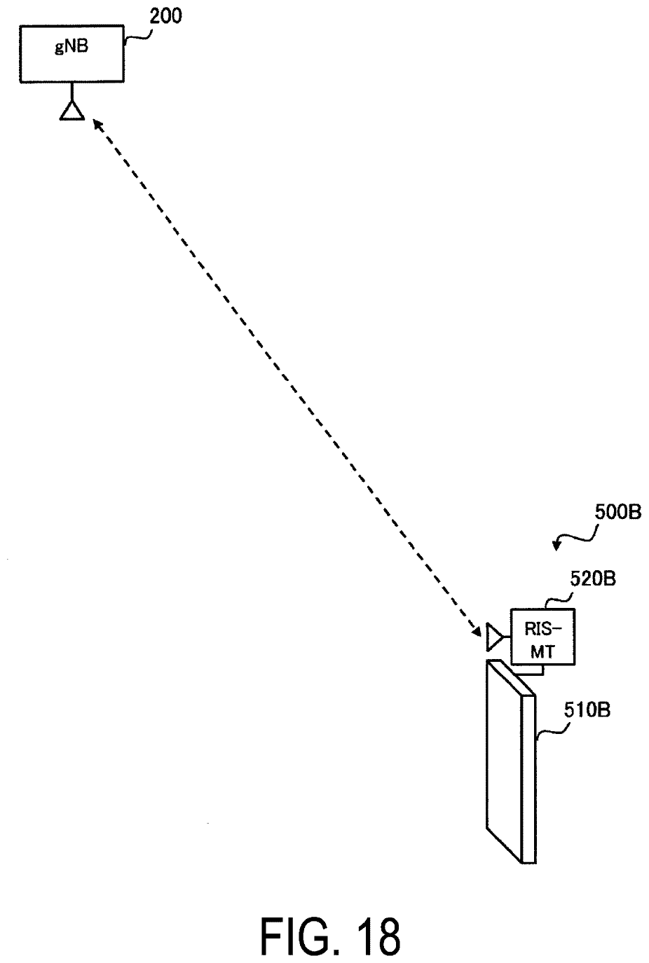

A second embodiment will be described mainly focusing on differences from the above-described embodiments. As illustrated in FIG. 18, a relay apparatus according to the second embodiment is a Reconfigurable Intelligent Surface (RIS) apparatus 500B configured to perform relay transmission that changes a propagation direction of an incident radio wave (radio signal) through reflection or refraction. The “NCR” in the above-described embodiments may be read as the “RIS”.

The RIS is a type of a relay device (hereinafter, also referred to as a “RIS-Fwd”) capable of performing beam forming (directivity control) in the same way as and/or a similar way to that of the NCR by changing characteristics of a metamaterial. The RIS may be able to change a range (distance) of a beam by controlling a reflection direction and/or a refraction direction of each unit element. For example, the RIS may have a configuration capable of controlling the reflection direction and/or refraction direction of each unit element, and focusing on a near UE (directing a beam) or focusing on a far UE (directing a beam).

The RIS apparatus 500B includes a new UE (hereinafter referred to as “RIS-MT”) 520B that is a control terminal for controlling a RIS-Fwd 510B. The RIS-MT 520B controls the RIS-Fwd 510B in cooperation with the gNB 200 by establishing a wireless connection to the gNB 200 and performing wireless communication with the gNB 200. The RIS-Fwd 510B may be a reflective RIS. Such a RIS-Fwd 510B reflects an incident radio wave to change the propagation direction of the radio wave. Here, a reflection angle of the radio wave can be variably set. The RIS-Fwd 510B reflects radio waves incident from the gNB 200 toward the UE 100. The RIS-Fwd 510B may be a transmissive RIS. Such a RIS-Fwd 510B refracts an incident radio wave to change the propagation direction of the radio wave. Here, a refraction angle of the radio wave can be variably set.

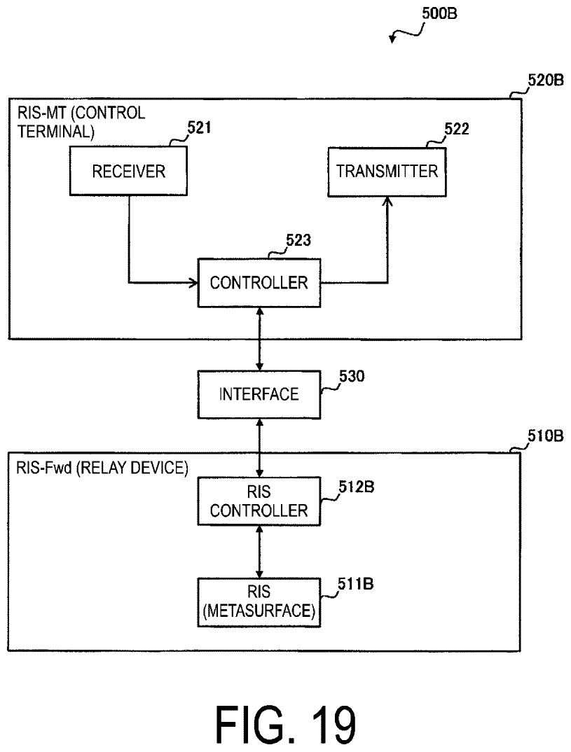

FIG. 19 is a diagram illustrating a configuration example of the RIS-Fwd (relay device) 510B and the RIS-MT (control terminal) 520B according to the second embodiment. The RIS-MT 520B has a receiver 521, a transmitter 522, and a controller 523. Such a configuration is the same as and/or similar to that of the above-described embodiment. The RIS-Fwd 510B includes a RIS 511B and a RIS controller 512B. The RIS 511B is a metasurface configured using a metamaterial. For example, the RIS 511B is configured by disposing extremely small structures relative to the wavelength of radio waves in an array, and the direction and/or beam shape of the reflected waves can be freely designed by making the structures different shapes depending on their disposition location. The RIS 511B may be a transparent dynamic metasurface. The RIS 511B may be configured by stacking a transparent glass substrate on transparent version of a metasurface substrate on which a large number of small structures are regularly disposed, and may be capable of dynamically controlling three patterns of a mode of transmitting an incident radio wave, a mode of transmitting a part of a radio wave and reflecting a part thereof, and a mode of reflecting all radio waves by minutely moving the stacked glass substrate. The RIS controller 512B controls the RIS 511B in response to a RIS control signal from the controller 523 in the RIS-MT 520B. The RIS controller 512B may include at least one processor and at least one actuator. The processor interprets a RIS control signal from the controller 523 in the RIS-MT 520B to drive the actuator in response to the RIS control signal.

### (3) Another Embodiment

In the above-described embodiment, the example in which the relay apparatus that performs relay transmission is the NCR apparatus 500A or the RIS apparatus 500B has been described. However, the relay apparatus that performs relay transmission is not limited to the NCR apparatus 500A or the RIS apparatus 500B, and may be an Integrated Access and Backhaul (IAB) node defined in the technical specifications of 3GPP.

The operation flows described above can be separately and independently implemented, and also be implemented in combination of two or more of the operation flows. For example, one or some steps of one operation flow may be added to another operation flow or one or some steps of one operation flow may be replaced with one or some steps of another operation flow. In each flow, all steps need not necessarily be performed, and only one or some of the steps may be performed.

In the above-described embodiment, an example in which the base station is an NR base station (gNB) has been described, but the base station may be an LTE base station (eNB). The base station may be a relay node such as an IAB node. The base station may be a Distributed Unit (DU) of the IAB node.

That is, the UE 100 may be a terminal function unit (a type of communication module) for a base station to control a relay device that performs signal relay. Such a terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the core network apparatus and at least a part of the base station.

A program that causes a computer to execute each of the processes that are performed by the communication apparatus according to the embodiments described above, for example, the UE 100 (NCR-MT 520A and RIS-MT 520B), the gNB 200, or the relay apparatus may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing the respective processes that are to be performed by the UE 100, the gNB 200, or the relay apparatus may be integrated, and at least a part of the UE 100, the gNB 200, or the relay apparatus may be configured as a semiconductor integrated circuit (chipset or System on a Chip (SoC)).

Functions that the UE 100, the gNB 200 (network node), or the relay apparatus enables may be implemented in circuitry or processing circuitry that includes a general-purpose processor, a special-purpose processor, an integrated circuit, an Application Specific Integrated Circuit (ASIC), a Central Processing Unit (CPU), a conventional circuit, and/or combinations thereof programmed to enable the described functions. The processor may include transistors and other circuits and may be considered as circuitry or processing circuitry. The processor may be a programmed processor that executes a program stored in the memory. As used herein, circuitry, a unit, means are hardware programmed to achieve, or hardware that performs, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### (4) Supplementary Notes

Features relating to the embodiments described above will be described below as supplementary notes.

### Supplementary Note 1

A communication method using a relay apparatus including a relay device configured to perform relay transmission of relaying a radio signal and a control terminal configured to control the relay device, the communication method including the steps of:
communicating, by a user equipment, information regarding a beam formed by the relay device to the control terminal and/or a network node; and
performing, by the user equipment, sidelink communication with another user equipment via the relay device based on the communicating.

### Supplementary Note 2

The communication method according to Supplementary Note 1, wherein
the communicating includes receiving, from the control terminal via a sidelink, beam forming information regarding a configuration of the beam formed by the relay device.

### Supplementary Note 3

The communication method according to Supplementary Note 1, wherein
the communicating includes receiving, from the network node in a downlink, beam forming information regarding a configuration of the beam formed by the relay device.

### Supplementary Note 4

The communication method according to Supplementary Note 2 or 3, wherein
the beam forming information includes, for each of a plurality of the beams formed by the relay device, at least one selected from the group consisting of a beam identifier of a corresponding one of the plurality of beams, information indicating a characteristic of the corresponding one of the plurality of beams, and information indicating a timing of forming the corresponding one of the plurality of beams.

### Supplementary Note 5

The communication method according to Supplementary Note 2 or 3, wherein
the performing of the sidelink communication includes the steps of:
attempting the sidelink communication based on the beam forming information; and
performing the sidelink communication at a timing of forming, by the relay device, a beam satisfying a predetermined condition among the plurality of beams, based on a result of the attempting.

### supplementary Note 6

The communication method according to any one of Supplementary Notes 1 to 5, wherein
the communicating includes transmitting, to the control terminal via a sidelink, notification information regarding a beam configuration of the relay device, the beam configuration being desired by the user equipment.

### Supplementary Note 7

The communication method according to any one of Supplementary Notes 1 to 5, wherein
the communicating includes transmitting, to the network node in an uplink, notification information regarding a beam configuration of the relay device, the beam configuration being desired by the user equipment.

### Supplementary Note 8

The communication method according to Supplementary Note 6 or 7, wherein
the communicating further includes receiving, from the control terminal or the network node, beam forming information regarding a configuration of the beam formed by the relay device, and
the notification information is based on the beam forming information.

### Supplementary Note 9

A user equipment used in a mobile communication system including a relay apparatus including a relay device configured to perform relay transmission of relaying a radio signal and a control terminal configured to control the relay device, the user equipment including:
a wireless communicator configured to communicate information regarding a beam formed by the relay device to the control terminal and/or a network node; and
a controller configured to perform sidelink communication with another user equipment via the relay device based on the communication.

### Supplementary Note 10

A relay apparatus including:
a relay device configured to perform relay transmission of relaying a radio signal; and
a control terminal configured to control the relay device,
wherein the control terminal is configured to communicate information regarding a beam formed by the relay device to a user equipment and/or a network node, and
the relay device is configured to relay sidelink communication between the user equipment and another user equipment based on the communication.

### REFERENCE SIGNS

1: Mobile communication system
100: UE
200: gNB
210: Transmitter
220: Receiver
230: Controller
240: Backhaul communicator
300A: AMF
400: OAM server
500A: NCR apparatus
510A: NCR-Fwd
520A: NCR-MT
500B: RIS apparatus
510B: RIS-Fwd
520B: RIS-MT
511A: Wireless unit
511a: Antenna unit
511b: RF circuit
511c: Directivity controller
512A: NCR controller
512B: RIS controller
521: Receiver
522: Transmitter
523: Controller
530: Interface
550: Sensor

1. A communication method using a relay apparatus comprising a relay device configured to perform relay transmission of relaying a radio signal and a control terminal configured to control the relay device, the communication method comprising:
communicating, by a user equipment, information regarding a beam forms by the relay device to the control terminal and/or a network node; and
performing, by the user equipment, sidelink communication with another user equipment via the relay device based on the communicating.

2. The communication method according to claim 1, wherein
the communicating comprises receiving, from the control terminal via a sidelink, beam forming information regarding a configuration of the beam formed by the relay device.

3. The communication method according to claim 1, wherein
the communicating comprises receiving, from the network node in a downlink, beam forming information regarding a configuration of the beam formed by the relay device.

4. The communication method according to claim 2, wherein
the beam forming information comprises, for each of a plurality of the beams formed by the relay device, at least one selected from the group consisting of a beam identifier of a corresponding one of the plurality of beams, information indicating a characteristic of the corresponding one of the plurality of beams, and information indicating a timing of forming the corresponding one of the plurality of beams.

5. The communication method according to claim 2, wherein
the performing of the sidelink communication comprises:
attempting the sidelink communication based on the beam forming information; and
performing the sidelink communication at a timing of forming, by the relay device, a beam satisfying a predetermined condition among the plurality of beams, based on a result of the attempting.

6. The communication method according to claim 1, wherein
the communicating comprises transmitting, to the control terminal via a sidelink, notification information regarding a beam configuration of the relay device, the beam configuration being desired by the user equipment.

7. The communication method according to claim 1, wherein
the communicating comprises transmitting, to the network node in an uplink, notification information regarding a beam configuration of the relay device, the beam configuration being desired by the user equipment.

8. The communication method according to claim 6, wherein
the communicating further comprises receiving, from the control terminal or the network node, beam forming information regarding a configuration of the beam formed by the relay device, and
the notification information is based on the beam forming information.

9. A user equipment used in a mobile communication system comprising a relay apparatus comprising a relay device configured to perform relay transmission of relaying a radio signal and a control terminal configured to control the relay device, the user equipment comprising:
a wireless communicator configured to communicate information regarding a beam formed by the relay device to the control terminal and/or a network node; and
a controller configured to perform sidelink communication with another user equipment via the relay device based on the communication.

10. A relay apparatus comprising:
a relay device configured to perform relay transmission of relaying a radio signal; and
a control terminal configured to control the relay device,
wherein the control terminal is configured to communicate information regarding a beam formed by the relay device to a user equipment and/or a network node, and
the relay device is configured to relay sidelink communication between the user equipment and another user equipment based on the communication.
